(19) United States
(12) Patent Application Publication
(10) Pub. No.: US 2017/0292067 A1
(43) Pub. Date: Oct. 12, 2017

(54) VANADIUM OXIDE-CONTAINING PARTICLES EACH HAVING CORE-SHELL STRUCTURE

(71) Applicant: Konica Minolta, Inc., Tokyo (JP)

(72) Inventor: Takashi WASHIZU, Hachioji-shi, Tokyo (JP)

(21) Appl. No.: 15/513,077

(22) PCT Filed: Oct. 2, 2015
(86) PCT No.: PCT/JP2015/078030

§ 371 Date: Mar. 21, 2017

(30) Foreign Application Priority Data
Oct. 3, 2014 (JP) 2014-204958

(51) Int. Cl. C09K 9/00; G02F 1/00; C09C 1/00

(52) U.S. Cl. CPC C09K 9/00; C09C 1/00; G02F 1/009; C01P 2004/84; C01P 2006/32; C01P 2006/60

(57) ABSTRACT

An object of the present invention is to provide vanadium oxide-containing particles each having a core-shell structure, which are excellent in thermochromic property and durability.

The vanadium oxide-containing particles each having a core-shell structure (1) each has (2) a core layer, which contains vanadium dioxide as a major component, and (4) a shell layer, which contains vanadium oxide containing vanadium having a valency number other than four as a major component.

### TECHNICAL FIELD

The present invention relates to vanadium oxide-containing particles each having a core-shell structure. More specifically, the present invention relates to vanadium oxide-containing particles each having a core-shell structure, which are excellent in thermochromic property and durability.

### BACKGROUND ART

Vanadium dioxide (VO₂) gains attention as a material that shows a thermochromic phenomenon, in which optical properties such as light absorbance and light reflectance are reversibly changed due to a change in temperature.

Meanwhile, in the crystal structures of vanadium dioxide, polymorphism of several crystalline phases such as phase A, phase B, phase C and phase R (so-called “rutile-type crystalline phase”) is present. Among these, the crystal structure that shows the above-mentioned thermochromic phenomenon is limited to phase R. This phase R has a monoclinic structure at a transition temperature or less, and thus is also referred to as phase M. In order to express substantially fine thermochromic property in such vanadium dioxide-containing particles, it is desirable that the vanadium dioxide-containing particles are not aggregated, have an average particle size of on the order of nanometers (100 nm or less), and the particles each has an isotropic shape.

In order to obtain excellent thermochromic property and transparency, it is necessary to make the particle sizes homogeneous and small as possible, but it is difficult to prevent the aggregation of the particles.

Furthermore, the synthesized vanadium dioxide particles have an excellent thermochromic property, but are unstable in structure, and thus are easily oxidized after the synthesis to turn into divanadium pentoxide (V₂O₅) or the like, and lose their thermochromic property.

Patent Literatures 1 and 2 each discloses a technique for preventing vanadium dioxide particles from deterioration and aggregation by subjecting the surfaces of the particles to surface modification. However, in general wet surface modification methods as disclosed in said Patent Literatures 1 and 2, since the particles are subjected to surface modification after undergoing a drying step, the vanadium dioxide is very unstable. As a result, deterioration has already progressed and aggregation has occurred before the surface modification is conducted, and thus sufficient surface modification cannot be conducted.

Furthermore, Patent Literature 3 also discloses a technique for preventing particles from deterioration by subjecting the particles to surface modification. However, since a vanadium dioxide powder body is dispersed again and subjected to surface modification, the particles has already aggregated in a powder body, and thus the dispersion is insufficient.

Furthermore, in surface modification with a silane coupling agent or the like, since a difference in refractive indices between vanadium dioxide particles and SiO₂ is great, light is reflected at the interface between vanadium dioxide particles and SiO₂, and thus thermochromic property cannot be efficiently obtained.

### CITATION LIST

### Patent Literature

Patent Literature 1: JP 2011-178825 A

Patent Literature 2: JP 2010-31235 A

Patent Literature 3: JP 2013-75806 A

### SUMMARY OF INVENTION

### Technical Problem

The present invention has been made in view of the above-mentioned problem and situation, and the problem to be solved by the present invention is to provide vanadium oxide-containing particles each having a core-shell structure, which are excellent in thermochromic property and durability.

### Solution to Problem

In order to solve the above-mentioned problem, the present inventors found, in the process of the consideration of the cause of the above-mentioned problem, and the like, that vanadium oxide-containing particles each having a core-shell structure, which are excellent in thermochromic property and durability can be provided by that a core layer contains vanadium dioxide as a major component and a shell layer contains vanadium oxide containing vanadium having a valency number other than four as a major component, and achieved the present invention.

Specifically, the above-mentioned problem in the present invention is solved by the following means.

1. Vanadium oxide-containing particles having thermochromic property each having a core-shell structure including:

a core layer containing vanadium dioxide as a major component; and

a shell layer containing vanadium oxide containing vanadium having a valency number other than four as a major component.

2. The vanadium oxide-containing particles each having a core-shell structure according to Item. 1, wherein the content of the vanadium oxide containing vanadium having a valency number other than four is 50% by mass or more with respect to the total mass of the shell layer.

3. The vanadium oxide-containing particles each having a core-shell structure according to Item. 2, wherein the content of the vanadium oxide containing vanadium having a valency number other than four is 70% by mass or more with respect to the total mass of the shell layer.

4. The vanadium oxide-containing particles each having a core-shell structure according to any one of Items. 1 to 3, wherein the shell layer has a layer thickness that is within a range of 2.5 to 25% of an average particle size of the vanadium oxide-containing particles each having a core-shell structure.

5. The vanadium oxide-containing particles each having a core-shell structure according to any one of Items. 1 to 4, wherein the vanadium oxide containing vanadium having a valency number other than four is V₂O₃, V₃O₅, V₆O₁₃, V₃O₇ or V₂O₅.

6. The vanadium oxide-containing particles each having a core-shell structure according to Item. 5, wherein the vanadium oxide containing vanadium having a valency number other than four is V₂O₃ or V₂O₅.

7. A film including the vanadium oxide-containing particles each having a core-shell structure according to any one of Items. 1 to 6.

### Advantageous Effect of Invention

According to the above-mentioned means of the present invention, vanadium oxide-containing particles each having a core-shell structure, which are excellent in thermochromic property and durability can be provided.

The mechanism of emergence of the effect and the mechanism of action of the present invention have not been clarified, but are conjectured as follows.

There was a problem that, since tetravalent vanadium in vanadium dioxide-containing particles is very unstable and thus is oxidized to turn into pentavalent vanadium, and then turns into divanadium pentoxide (V₂O₅), which shows no thermochromic property.

In the present invention, it is considered that, by covering the surfaces of vanadium dioxide-containing particles with a stable vanadium oxide, the vanadium dioxide-containing particles can be protected, that is, the durability thereof can be improved without using surface modification by a known wet process, or the like.

On the other hand, it is considered that, when a layer containing vanadium oxide containing vanadium having different valency number (shell layer) is disposed in such way, the difference in refractive indices is also small, and reflection is difficult to occur between the vanadium dioxide-containing particle (core layer) and the shell layer, and thus an efficient thermochromic property can be obtained.

### BRIEF DESCRIPTION OF DRAWINGS

FIG. 1 is a schematic cross-sectional drawing showing an example of the vanadium oxide-containing particles each having a core-shell structure of the present invention.

### DESCRIPTION OF EMBODIMENTS

Vanadium oxide-containing particles each having a core-shell structure of the present invention each has a core layer containing vanadium dioxide as a major component, and a shell layer containing vanadium oxide containing vanadium having a valency number other than four as a major component. This feature is a technical feature that is common in the inventions as claimed in claims 1 to 6.

As an embodiment of the present invention, from the viewpoint of the improvement of the thermochromic property before a deterioration test, the content of the vanadium oxide containing vanadium having a valency number other than four is preferably 50% by mass or more, more preferably 70% by mass or more with respect to the total mass of the shell layer, and the layer thickness of the shell layer is preferably within the range of 2.5 to 25% of the average particle size of the vanadium oxide-containing particles each having a core-shell structure.

Furthermore, from the viewpoint of the improvement of the thermochromic property and durability, the vanadium oxide containing vanadium having a valency number other than four is preferably V₂O₃, V₃O₅, V₆O₁₃, V₃O₇ or V₂O₅, more preferably V₂O₃ or V₂O₅.

Furthermore, the vanadium oxide-containing particles each having a core-shell structure of the present invention can be applied to a film having an optical function layer and the like.

The present invention and the constitutional elements thereof, and the forms and embodiments for carrying out the present invention will be explained in detail. In the present application, “to”, which represents a numerical range, is used in the meaning that the numerical values described before and after that word are encompassed as a lower limit value and an upper limit value.

<<Vanadium Oxide-Containing Particles Each Having a Core-Shell Structure>>

The vanadium oxide-containing particles each having a core-shell structure of the present invention each has a core layer containing vanadium dioxide as a major component, and a shell layer containing vanadium oxide containing vanadium having a valency number other than four as a major component.

A detailed explanation will be made by using a drawing.

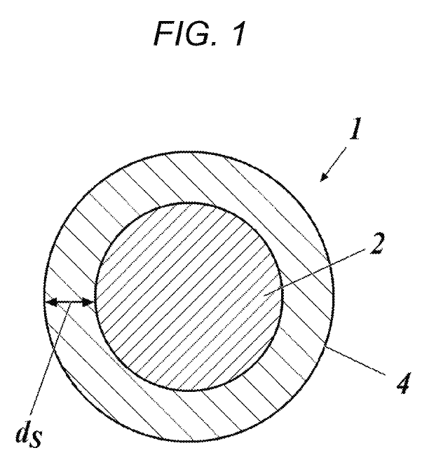

As shown in FIG. 1, the vanadium oxide-containing particles each having a core-shell structure of the present invention 1 are each constituted by a core layer 2, and a shell layer 4 that covers the core layer 2, and the core layer 2 contains vanadium dioxide as a major component, and the shell layer 4 contains vanadium oxide containing vanadium having a valency number other than four as a major component. The vanadium dioxide contained in the core layer 2 has a crystal structure of phase R (phase M).

The “major component” used in the present invention refers to that, in the core layer, vanadium dioxide is contained by 70% by mass or more, preferably by 75% by mass or more, more preferably by 80% by mass or more with respect to the total mass of the core layer, and in the shell layer, the vanadium oxide containing vanadium having a valency number other than four is contained by 50% by mass or more, preferably by 70% by mass or more, more preferably by 80% by mass or more with respect to the total mass of the shell layer.

The vanadium oxide-containing particles each having a core-shell structure 1 of the present invention have light absorbability and thermochromic property.

The thermochromic property possessed by the vanadium oxide-containing particles each having a core-shell structure 1 is not specifically limited as long as optical properties such as light absorbance and light reflectance are reversibly changed by a change in temperature.

For example, for a film in which the vanadium oxide-containing particles each having a core-shell structure of the present invention are incorporated (hereinafter also referred to as a vanadium oxide-mixed film), a difference in light transmittances at 25° C./50% RH and 85° C./85% RH is preferably 25% or more, more preferably 30% or more.

The light transmittance of the vanadium oxide-mixed film can be measured, for example, as a light transmittance at a wavelength of 2,000 nm by using a spectrometer V-670 (manufactured by JASCO Corporation).

Furthermore, the vanadium oxide-containing particles each having a core-shell structure 1 of the present invention has an average particle size of, preferably 100 nm or less, more preferably 50 nm or less, since the light permeability of the vanadium oxide-mixed film or the like and the thermochromic property are obtained by suppressing scattering of light.

The layer thickness dₛ of the shell layer 4 is preferably in the range of 2.5 to 25% of the average particle size of the vanadium oxide-containing particles each having a core-shell structure 1.

In the present invention, the average particle size of the vanadium oxide-containing particles each having a core-shell structure 1 can be measured by image processing of a transmission-type electronmicroscopic picture (TEM cross-sectional surface).

In the present invention, an average value of the particle sizes of 100 vanadium oxide-containing particles is set as the average particle size.

The respective layers that constitute each vanadium oxide-containing particles each having a core-shell structure 1, and a method for producing the particles will be explained below.

<Core Layer>

The core layer in the present invention contains at least vanadium dioxide as a major component. The core layer may also contain components other than vanadium dioxide, or may be constituted by only vanadium dioxide.

The vanadium dioxide contained in the core layer has a crystal structure of phase R (phase M).

<Shell Layer>

The shell layer in the present invention contains vanadium oxide containing vanadium having a valency number other than four as a major component.

The vanadium having a valency number other than four refers to vanadium having a valency number in the range of 3 to 5 except for four.

The vanadium oxide containing vanadium having a valency number other than four is not specifically limited, and examples include V₂O₃, V₃O₅, V₆O₁₃, V₃O₇, V₂O₅ and the like, of which V₂O₃ or V₂O₅ is preferable.

<<Preparation of Aqueous Dispersion Liquid of Vanadium Oxide-Containing Particles Each Having Core-Shell Structure>>

(1) Preparation of Aqueous Dispersion Liquid of Vanadium Dioxide-Containing Particles

As a method for forming vanadium dioxide-containing particles, for example, a formation method using a hydrothermal reaction is known, but the method is not specifically limited as long as the an aqueous dispersion liquid of vanadium dioxide-containing particles can be prepared.

An example of the method for preparing an aqueous dispersion liquid of vanadium dioxide-containing particles is shown below.

To an aqueous solution obtained by mixing 2 ml of 35% by mass aqueous hydrogen peroxide (manufactured by Wako Pure Chemical Industries, Ltd.) and 20 ml of pure water is added 0.5 g of divanadium pentoxide (V) (V₂O₅, special grade, manufactured by Wako Pure Chemical Industries, Ltd.), the mixture is stirred at 30° C. for 4 hours, a 5% by mass aqueous solution of hydrazine monohydrate (N₂H₄.H₂O, special grade, manufactured by Wako Pure Chemical Industries, Ltd.) is then added dropwise slowly, whereby a solution having a pH value (25° C.) of 4.2 is prepared.

The prepared mixed solution is put into a high-pressure reaction decomposition vessel, standing type HU 50 ml set (an outer cylinder made of pressure-resistant stainless, a sample vessel made of PTFE HUTc-50: manufactured by SAN-AI Kagaku Co. Ltd.), heated at 100° C. for 8 hours, and subjected to a hydrothermal reaction treatment at 270° C. for 48 hours, whereby an aqueous dispersion liquid of vanadium dioxide-containing particles is prepared.

(2) Preparation of Vanadium Oxide-Containing Particles Each Having Core-Shell Structure

By subjecting the aqueous dispersion liquid of vanadium dioxide-containing particles prepared as above to an oxidation reaction or a reduction reaction, vanadium oxide-containing particles each having a core-shell structure each having a layer in which only the surfaces of the vanadium dioxide-containing particles have been oxidized or reduced, i.e., a shell layer containing vanadium oxide containing vanadium having a valency number other than four as a major component, and a core layer containing vanadium dioxide that has not been oxidized or reduced as a major component can be prepared.

The oxidation reaction and reduction reaction will be respectively explained below.

(2.1) Oxidation Reaction

Firstly, the prepared aqueous dispersion liquid of the vanadium dioxide-containing particles is washed by using ultrafiltration, and concentrated so as to be an aqueous dispersion liquid of 5% by mass.

An oxidizing agent is mixed with this solution, and the mixture is stirred at an ordinary temperature (25° C.) and immediately washed by using ultrafiltration, whereby a shell layer containing vanadium oxide containing vanadium having a valency number other than four (for example, V₆O₁₃, V₃O₇, V₂O₅ or the like) as a major component can be formed.

The concentration of the oxidizing agent is preferably within the range of 0.1 to 3.0% by mass with respect to the total mass.

The addition amount of the oxidizing agent is preferably within the range of 0.01 to 0.3 parts by mass with respect to 100 parts by mass of the vanadium dioxide-containing particles.

The stirring time is preferably in the range of 30 seconds to 3 minutes.

In the above-mentioned oxidation reaction, the composition of the vanadium oxide that constitutes the shell layer can be controlled by adjusting the concentration of the oxidizing agent. Furthermore, by adjusting the amount of the oxidizing agent, the content of the vanadium oxide containing vanadium having a valency number other than four contained in the shell layer can be controlled. Furthermore, by adjusting the stirring time, the layer thickness of the shell layer can be controlled.

The oxidizing agent is not specifically limited, and examples include nitric acid, hydrogen peroxide, perchloric acids and the like. One kind of oxidizing agent may be singly used, or two or more kinds of oxidizing agents may be used in combination.

(2.2) Reduction Reaction

Firstly, the prepared aqueous dispersion liquid of the vanadium dioxide-containing particles is washed by using ultrafiltration, and concentrated so as to be an aqueous dispersion liquid of 5% by mass.

A reducing agent is mixed with this solution, and a hydrothermal reaction is conducted, whereby a shell layer containing vanadium oxide containing vanadium having a valency number other than four (for example, V₂O₃, V₃O₅ or the like) as a major component can be formed.

The concentration of the reducing agent is preferably in the range of 5 to 20% by mass with respect to the total mass.

The reaction temperature and reaction time of the hydrothermal reaction are preferably such that the hydrothermal reaction is conducted at a reaction temperature in the range of 230 to 270° C. for 3 to 24 hours.

In the above-mentioned reduction reaction, by adjusting the amount of the reducing agent, the content of the vanadium oxide containing vanadium having a valency number other than four contained in the shell layer can be controlled. Furthermore, by adjusting the reaction temperature, the layer thickness of the shell layer can be controlled. Furthermore, by adjusting the reaction temperature, the composition of the vanadium oxide that constitutes the shell layer can be controlled.

The reducing agent is not specifically limited, and examples include organic acids such as hydrazine, oxalic acid, tartaric acid and citric acid, and the like. One kind of reducing agent may be singly used, or two or more kinds of reducing agents may be used in combination.

### Other Embodiments

In the case when the vanadium oxide-containing particles each having a core-shell structure of the present invention is used by incorporating in a film or the like, an UV absorbing agent and an antioxidant may be used in combination.

By using the UV absorbing agent, the deterioration of the film is prevented, and UV light is converted to heat, whereby the phase transition of the vanadium dioxide can be generated more efficiently.

Furthermore, by using the antioxidant, the deterioration of the vanadium oxide-containing particles each having a core-shell structure can further be prevented.

<UV Absorbing Agent>

As the UV absorbing agent, inorganic UV absorbing agents and organic UV absorbing agents are exemplified.

(1) Inorganic UV Absorbing Agent

The inorganic UV absorbing agent is mainly a metal oxide pigment, and is preferably selected from titanium oxide, zinc oxide, iron oxide, zirconium oxide, cerium oxide or mixtures thereof.

Furthermore, it is preferable that the inorganic UV absorbing agent has a refractive index of 2.4 or less. In an inorganic UV absorbing agent having a refractive index of more than 2.4, significant scatter reflection occurs, and causes decrease in the transparency and decrease in the normal light reflectance of a UV absorbing agent-containing film are caused. Therefore, it is preferable that the refractive index is within the range of 1.5 to 2.4.

The refractive index herein refers to a numerical value measured at the wavelength of sodium D-line (wavelength: 589 nm) at a temperature of 25° C.

Furthermore, in view of improving the transparency of the inorganic UV absorbing agent-containing film, it is preferable that the inorganic UV absorbing agent has an average particle size within the range of 5 to 500 nm, and metal oxide particles being within the range of 10 to 100 nm and having the maximum particle size in particle size distribution of 150 nm or less are specifically preferable.

The use amount of the inorganic UV absorbing agent is within the range of 1 to 30% by mass, preferably 5 to 25% by mass, further preferably 15 to 20% by mass with respect to the total mass of the binder contained in the film. When the use amount is greater than 30% by mass, the tight adhesiveness is deteriorated, whereas when the use amount is less than 1% by mass, the effect of improving weather resistance is small.

Furthermore, in the case when the inorganic UV absorbing agent is used in combination with an organic UV absorbing agent, which will be mentioned below, the use amount of the inorganic UV absorbing agent is in the range of 3 to 20% by mass, preferably 5 to 10% by mass with respect to the total mass of the UV absorbing agent-containing film, and the use amount of the organic UV absorbing agent is within the range of 0.1 to 10% by mass, preferably 0.5 to 5% by mass.

When the inorganic UV absorbing agent and the organic UV absorbing agent are used in combination in the above-mentioned ranges of use amounts, the UV absorbing agent-containing film has high transparency and fine weather resistance.

(2) Organic UV Absorbing Agent

Examples of the organic UV absorbing agent include benzophenone-based, benzotriazole-based, phenyl salicylate-based, hindered amine-based and triazine-based organic UV absorbing agents, and the like.

Examples of the benzophenone-based ultraviolet absorbers include 2,4-dihydroxy-benzophenone,
2-hydroxy-4-methoxy-benzophenone,
2-hydroxy-4-n-octoxy-benzophenone,
2-hydroxy-4-dodecyloxy-benzophenone,
2-hydroxy-4-octadecyloxy-benzophenone,
2,2′-dihydroxy-4-methoxy-benzophenone,
2,2′-dihydroxy-4,4′-dimethoxy-benzophenone,
2,2′,4,4′-tetrahydroxy-benzophenone and the like.

Examples of the benzotriazole-based ultraviolet absorbers include 2-(2′-hydroxy-5-methylphenyl)benzotriazole,
2-(2′-hydroxy-3′,5′-di-t-butylphenyl)benzotriazole,
2-(2′-hydroxy-3′-t-butyl-5′-methylphenyl)benzotriazole and the like.

Examples of the phenyl salicylate-based ultraviolet absorbers include phenyl salicylate,
2-4-di-t-butylphenyl-3,5-di-t-butyl-4-hydroxybenzoate and the like.

Examples of the hindered amine-based ultraviolet absorbers include
bis(2,2,6,6-tetramethylpiperidin-4-yl)sebacate and the like.

Examples of the triazine-based ultraviolet absorber include
2,4-diphenyl-6-(2-hydroxy-4-methoxyphenyl)-1,3,5-triazine,
2,4-diphenyl-6-(2-hydroxy-4-ethoxyphenyl)-1,3,5-triazine,
2,4-diphenyl-(2-hydroxy-4-propoxyphenyl)-1,3,5-triazine,
2,4-diphenyl-(2-hydroxy-4-butoxyphenyl)-1,3,5-triazine,
2,4-diphenyl-6-(2-hydroxy-4-butoxyphenyl)-1,3,5-triazine,
2,4-diphenyl-6-(2-hydroxy-4-hexyloxyphenyl)-1,3,5-triazine,
2,4-diphenyl-6-(2-hydroxy-4-octyloxyphenyl)-1,3,5-triazine,
2,4-diphenyl-6-(2-hydroxy-4-dodecyloxyphenyl)-1,3,5-triazine,
2,4-diphenyl-6-(2-hydroxy-4-benzyloxyphenyl)-1,3,5-triazine and the like.

The organic UV absorbing agent includes, besides the above-mentioned UV absorbing agents, compounds having a function to convert an energy possessed by ultraviolet lay to an oscillation energy, and release the oscillation energy as a heat energy or the like.

The use amount of the organic UV absorbing agent is within the range of 0.1 to 20% by mass, preferably 1 to 15% by mass, further preferably 3 to 10% by mass with respect to the total mass of the UV absorbing agent-containing film. When the use amount is greater than 20% by mass, the tight adhesiveness is deteriorated, whereas when the use amount is less than 0.1% by mass, the effect of improving weather resistance is small.

<Antioxidant>

The antioxidant can be selected from phenol-based compounds, hindered amine-based compounds, phosphorus-based compounds and sulfur-based compounds. Furthermore, these selectable compounds can be used in combination of two or more kinds.

Examples of the phenol-based antioxidants include hindered phenol-based antioxidants; “Irganox1076” and “Irganox1010” from Ciba Japan K. K., and trade names “AO-20”, “AO-30”, “AO-40”, “AO-50”, “AO-50F”, “AO-60”, “AO-70”, “AO-80” and “AO-330” manufactured by ADEKA Corporation, which have 2,6-dialkylphenol, and the like.

Examples of the amine-based antioxidants include hindered amine-based compounds, and for example, amine-based compounds that are commercially available from Ciba Japan K. K. under the trade names of “Tinuvin 144 (AO2)” and “Tinuvin 770”, and an amine-based compound that is commercially available from ADEKA Corporation under the trade name of “ADK STAB LA-52” are preferable.

Examples of the phosphorus-based antioxidants include, for example, phosphorus-based antioxidants that are commercially available from Sumitomo Chemical Co., Ltd. under the trade name of “Sumilizer GP” (AO2), from ADEKA Corporation under the trade names of “ADK STAB PEP-24G”, “ADK STAB PEP-36” (AO1) and “ADKSTAB 3010”, from Ciba Japan K. K. under the trade name of “IRGAFOS P-EPQ”(AO4), and from Sakai Chemical Industry Co., Ltd. under the trade name of “GSY-P101 (AO3)” are preferable.

Examples of the sulfur-based antioxidants include dialkylthiodipropionates such as dilauryl, dimyristyl, myristylstearyl and distearyl esters of thiodipropionate; and β-alkylmercaptopropionate esters of polyols such as pentaerythritol tetra(β-dodecylmercaptopropionate). Examples of these sulfur-based compounds are preferably sulfur-based compounds that are commercially available from Sumitomo Chemical Co., Ltd. under the trade names of “Sumilizer TPL-R” and “Sumilizer TP-D”.

In addition, benzotriazole-based compounds (for example, benzotriazole and the like), thiadiazole-based compounds (for example, 2-mercaptobenzothiazole and the like), L-ascorbic acid, sodium sulfite, sodium acetate and the like can also be used.

The use amount of the antioxidant is preferably in the range of 0.1 to 10% by mass, more preferably in the range of 1 to 5% by mass.

### EXAMPLES

The present invention will be explained below in detail with referring to Examples, but the present invention is not limited to these Examples. In the Examples, the indication of “%” will be used, and this indication represents “% by mass” unless otherwise specifically mentioned.

<<Preparation of Aqueous Dispersion Liquid of Vanadium Dioxide-Containing Particles>>

To an aqueous solution obtained by mixing 2 ml of 35% by mass aqueous hydrogen peroxide (manufactured by Wako Pure Chemical Industries, Ltd.) and 20 ml of pure water was added 0.5 g of divanadium pentoxide (V) (V₂O₅, special grade, manufactured by Wako Pure Chemical Industries, Ltd.), the mixture was stirred at 30° C. for 4 hours, and a 5% by mass aqueous solution of hydrazine monohydrate (N₂H₄.H₂O, special grade, manufactured by Wako Pure Chemical Industries, Ltd.) was added dropwise slowly, whereby a solution having a pH value (25° C.) of 4.2 was prepared.

The prepared mixed solution was put into a high-pressure reaction decomposition vessel, standing type HU 50 ml set (an outer cylinder made of pressure-resistant stainless, a sample vessel made of PTFE HUTc-50: manufactured by SAN-AI Kagaku Co. Ltd.), heated at 100° C. for 8 hours, and subjected to a hydrothermal reaction treatment at 270° C. for 48 hours.

The obtained product was washed by using ultrafiltration, and an aqueous dispersion liquid of the vanadium dioxide-containing particles was prepared.

<<Preparation of Sample of Vanadium Oxide-Containing Particles Each Having Core-Shell Structure>>

(1) Preparation of Sample 101

Sample 101 was the aqueous dispersion liquid of the vanadium dioxide-containing particles prepared above.

(2) Preparation of Sample 102

The aqueous dispersion liquid of the vanadium dioxide-containing particles was dried in a vacuum oven at 60° C. for 24 hours to generate vanadium dioxide-containing particles.

Subsequently, aqueous ammonia (28% by mass, manufactured by Wako Pure Chemical Industries, Ltd.) was added to a solution obtained by mixing 20 ml of ethanol and 5 ml of pure water, whereby a solution having a pH of 11.5 (25° C.) was prepared. To this solution were added 1 g of the prepared vanadium dioxide-containing particles and 0.3 g of methyltriethoxysilane (manufactured by Tokyo Kasei Kogyo Co., Ltd.), and the mixture was mixed by stirring at 30° C. for 4 hours.

The obtained suspension liquid was sequentially filtered and washed, and microparticles were collected.

The collected microparticles were subjected to a dry treatment at 110° C. for 1 hour to give surface-modified Sample 102.

(3) Preparation of Sample 103

The aqueous dispersion liquid of the vanadium dioxide-containing particles was washed by using ultrafiltration, and concentrated so as to be a 5% by mass aqueous dispersion liquid.

Twenty grams of this aqueous dispersion liquid was mixed with 2.0 g of a 10% by mass aqueous solution of hydrazine monohydrate (N₂H₄.H₂O, special grade, manufactured by Wako Pure Chemical Industries, Ltd.), and a hydrothermal reaction was conducted at 250° C. for 3 hours to give Sample 103.

(4) Preparation of Sample 104

The aqueous dispersion liquid of the vanadium dioxide-containing particles was washed by using ultrafiltration, and concentrated so as to be a 5% by mass aqueous dispersion liquid.

Twenty grams of this aqueous dispersion liquid was mixed with 3.0 g of a 10% by mass aqueous solution of hydrazine monohydrate (N₂H₄.H₂O, special grade, manufactured by Wako Pure Chemical Industries, Ltd.), and a hydrothermal reaction was conducted at 250° C. for 3 hours to give Sample 104.

(5) Preparation of Sample 105

The aqueous dispersion liquid of the vanadium dioxide-containing particles was washed by using ultrafiltration, and concentrated so as to be a 5% by mass aqueous dispersion liquid.

Twenty grams of this aqueous dispersion liquid was mixed with 3.0 g of a 10% by mass aqueous solution of hydrazine monohydrate (N₂H₄.H₂O, special grade, manufactured by Wako Pure Chemical Industries, Ltd.), and a hydrothermal reaction was conducted at 250° C. for 24 hours to give Sample 105.

(6) Preparation of Sample 106

The aqueous dispersion liquid of the vanadium dioxide-containing particles was washed by using ultrafiltration, and concentrated so as to be a 5% by mass aqueous dispersion liquid.

Twenty grams of this aqueous dispersion liquid was mixed with 3.0 g of a 10% by mass aqueous solution of hydrazine monohydrate (N₂H₄.H₂O, special grade, manufactured by Wako Pure Chemical Industries, Ltd.), and a hydrothermal reaction was conducted at 250° C. for 4 hours to give Sample 106.

(7) Preparation of Sample 107

The aqueous dispersion liquid of the vanadium dioxide-containing particles was washed by using ultrafiltration, and concentrated so as to be a 5% by mass aqueous dispersion liquid.

Twenty grams of this aqueous dispersion liquid was mixed with 3.0 g of a 10% by mass aqueous solution of hydrazine monohydrate (N₂H₄.H₂O, special grade, manufactured by Wako Pure Chemical Industries, Ltd.), and a hydrothermal reaction was conducted at 250° C. for 8 hours to give Sample 107.

(8) Preparation of Sample 108

The aqueous dispersion liquid of the vanadium dioxide-containing particles was washed by using ultrafiltration, and concentrated so as to be a 5% by mass aqueous dispersion liquid.

Twenty grams of this aqueous dispersion liquid was mixed with 3.0 g of a 10% by mass aqueous solution of hydrazine monohydrate (N₂H₄.H₂O, special grade, manufactured by Wako Pure Chemical Industries, Ltd.), and a hydrothermal reaction was conducted at 250° C. for 18 hours to give Sample 108.

(9) Preparation of Sample 109

The aqueous dispersion liquid of the vanadium dioxide-containing particles was washed by using ultrafiltration, and concentrated so as to be a 5% by mass aqueous dispersion liquid.

Twenty grams of this aqueous dispersion liquid was mixed with 4.5 g of a 10% by mass aqueous solution of hydrazine monohydrate (N₂H₄.H₂O, special grade, manufactured by Wako Pure Chemical Industries, Ltd.), and a hydrothermal reaction was conducted at 250° C. for 8 hours to give Sample 109.

(10) Preparation of Sample 110

The aqueous dispersion liquid of the vanadium dioxide-containing particles was washed by using ultrafiltration, and concentrated so as to be a 5% by mass aqueous dispersion liquid.

Twenty grams of this aqueous dispersion liquid was mixed with 10 g of a 0.5% by mass aqueous solution of hydrogen peroxide, and the mixture was stirred at an ordinary temperature (25° C.) for 1 minute and immediately washed by using ultrafiltration to give Sample 110.

(11) Preparation of Sample 111

The aqueous dispersion liquid of the vanadium dioxide-containing particles was washed by using ultrafiltration, and concentrated so as to be a 5% by mass aqueous dispersion liquid.

Twenty grams of this aqueous dispersion liquid was mixed with 4.5 g of a 10% by mass aqueous solution of hydrazine monohydrate (N₂H₄.H₂O, special grade, manufactured by Wako Pure Chemical Industries, Ltd.), and a hydrothermal reaction was conducted at 270° C. for 8 hours to give Sample 111.

(12) Preparation of Sample 112

The aqueous dispersion liquid of the vanadium dioxide-containing particles was washed by using ultrafiltration, and concentrated so as to be a 5% by mass aqueous dispersion liquid.

Twenty grams of this aqueous dispersion liquid was mixed with 10 g of a 1.0% by mass aqueous solution of hydrogen peroxide, and the mixture was stirred at an ordinary temperature (25° C.) for 1 minute and immediately washed by using ultrafiltration to give Sample 112.

<<Evaluation of Samples>>

Each of the prepared samples was evaluated as follows. The results of the evaluation are shown in Table 1.

(1) Crystal Structure

Each vanadium dioxide-containing particle before formation of a shell layer was measured by using an X-ray diffraction device (manufactured by Rigaku Corporation), and compared with a profile of a vanadium dioxide crystal formed of a known rutile-type crystal layer to thereby identify that the major component was a vanadium dioxide crystal having a rutile-type crystal layer.

(2) Photographing of Scanning Transmission Electron Microscope (STEM) Image

A powder of each sample of the obtained vanadium oxide was embedded in a nickel foil, and sliced by using a focused ion beam processing device to give a thin film sample for STEM analysis.

An STEM image of the above-mentioned thin film sample for analysis was obtained by using a field emission type electron microscope (manufactured by Hitachi High-Technologies Corporation, HD-2300) with presetting the acceleration voltage to 200 kV, the sample absorption current to 1×10⁻⁹ A and the beam diameter to 0.7 nmφ in diameter.

(3) Line Analysis in Electron Energy Loss Spectroscopy

Using an energy loss analysis device (GIF-Tridiem manufactured by Gatan, Inc) on the thin film sample for analysis, by presetting the acceleration voltage to 200 kV and the beam diameter to 0.7 nmφ in diameter, and by irradiating the thin film sample with a beam for 50 seconds, a line spectrum in an electron energy loss spectroscopy was obtained. In addition, the obtained line spectrum had a half width of energy resolution of about 1.0 eV and a line analysis uptake time of 2 sec/pixcel. The abundance ratio of the vanadium for every valency number was obtained from the obtained spectrum.

It was confirmed from the above-mentioned measurement that each sample had an average particle size of 30 nm.

(4) Measurement of Light Transmittance Difference (Before Deterioration Test)

Each prepared sample was mixed with polyvinyl alcohol so as to be 10% by mass, and a film for measurement having a thickness of 50 μm was prepared.

Using each film for measurement, the respective light transmittances at a wavelength 2,000 nm at 25° C./50% RH and 85° C./50% RH were measured, and the difference of the calculated light transmittances was evaluated according to the following evaluation criteria. The measurement was conducted by a spectrometer V-670 (manufactured by JASCO Corporation) with a temperature-regulating unit (manufactured by JASCO Corporation) attached thereto.

⊙: 30% or more excellent performance

◯: 25% or more and lower than 30% sufficient performance in practical use

×: lower than 25% insufficient performance in practical use

(5) Measurement of Light Transmittance Difference (After Deterioration Test)

Each film for measurement prepared above was stored at 25° C./50% RH for 24 hours, and then stored at 85° C./85% RH for 24 hours. This was repeated ten times, and the thermochromic property was evaluated.

Thereafter, in a similar manner to that mentioned above, the respective light transmittances at a wavelength 2,000 nm at 25° C./50% RH and 85° C./50% RH were measured, the difference in the light transmittances was calculated, and a deterioration resistance rate from the difference from the light transmittance before the deterioration test (=(light transmittance difference after deterioration test/light transmittance difference before deterioration test)×100) (%) was evaluated according to the following evaluation criteria, whereby the durability of the vanadium oxide-containing particles was evaluated.

⊙: 85% or more no problem

◯: 60% or more and lower than 85% no problem in practical use

×: lower than 60% problem in practical use

TABLE 1

| | Shell layer | | | | | | | | |
|---|---|---|---|---|---|---|---|---|---|
| | | | Layer | | | | | | |
| | | | thickness | | | | | | |
| | | Concentration | rate with | Before | | | | | |
| | | of vanadium | respect to | deterioration test | | After deterioration test | | | |
| | | oxide other | average | Difference in | | Difference in | Deterioration | | |
| | | than | particle | light | | light | resistance | | |
| Sample | | tetravalent | diameter | transmittances | | transmittances | rate | | |
| No. | Composition | (% by mass) | (%) | (%) | Evaluation | (%) | (%) | Evaluation | Remarks |
| 101 | — | — | — | 40 | ⊙ | 15 | 38 | X | Comparative |
| | | | | | | | | | Example |
| 102 | Methylethoxysilane | — | — | 24 | X | 20 | 83 | ◯ | Comparative |
| | | | | | | | | | Example |
| 103 | V₃O₅ | 50 | 1.5 | 37 | ⊙ | 23 | 62 | ◯ | Present |
| | | | | | | | | | Invention |
| 104 | V₃O₅ | 70 | 1.5 | 38 | ⊙ | 27 | 71 | ◯ | Present |
| | | | | | | | | | Invention |
| 105 | V₃O₅ | 70 | 28 | 30 | ⊙ | 27 | 90 | ⊙ | Present |
| | | | | | | | | | Invention |
| 106 | V₃O₅ | 70 | 2.5 | 38 | ⊙ | 29 | 76 | ◯ | Present |
| | | | | | | | | | Invention |
| 107 | V₃O₅ | 70 | 15 | 35 | ⊙ | 28 | 80 | ◯ | Present |
| | | | | | | | | | Invention |
| 108 | V₃O₅ | 70 | 25 | 32 | ⊙ | 26 | 81 | ◯ | Present |
| | | | | | | | | | Invention |
| 109 | V₃O₅ | 95 | 15 | 40 | ⊙ | 34 | 85 | ⊙ | Present |
| | | | | | | | | | Invention |
| 110 | V₆O₁₃ | 95 | 15 | 39 | ⊙ | 33 | 85 | ⊙ | Present |
| | | | | | | | | | Invention |
| 111 | V₂O₃ | 95 | 15 | 41 | ⊙ | 37 | 90 | ⊙ | Present |
| | | | | | | | | | Invention |
| 112 | V₂O₅ | 95 | 15 | 40 | ⊙ | 36 | 90 | ⊙ | Present |
| | | | | | | | | | Invention |

(6) Summary

As shown in Table 1, it was confirmed that Samples 103 to 112 of the present invention were excellent in thermochromic property and durability as compared to Samples 101 and 102 of Comparative Examples.

It is understood from above that it is useful that the core layer contains vanadium dioxide as a major component and the shell layer contains vanadium oxide containing vanadium having a valency number other than four as a major component.

### INDUSTRIAL APPLICABILITY

The present invention can be specifically and preferably utilized for providing vanadium oxide-containing particles each having a core-shell structure, which are excellent in thermochromic property and durability.

### REFERENCE SIGNS LIST

1 Vanadium oxide-containing particles each having a core-shell structure
2 Core layer
4 Shell layer
dₛ Layer thickness

1. Vanadium oxide-containing particles having thermochromic property each having a core-shell structure comprising:
a core layer containing vanadium dioxide as a major component; and
a shell layer containing vanadium oxide containing vanadium having a valency number other than four as a major component.

2. The vanadium oxide-containing particles each having a core-shell structure according to claim 1, wherein the content of the vanadium oxide containing vanadium having a valency number other than four is 50% by mass or more with respect to the total mass of the shell layer.

3. The vanadium oxide-containing particles each having a core-shell structure according to claim 2, wherein the content of the vanadium oxide containing vanadium having a valency number other than four is 70% by mass or more with respect to the total mass of the shell layer.

4. The vanadium oxide-containing particles each having a core-shell structure according to claim 1, wherein the shell layer has a layer thickness that is within a range of 2.5 to 25% of an average particle size of the vanadium oxide-containing particles each having a core-shell structure.

5. The vanadium oxide-containing particles each having a core-shell structure according to claim 1, wherein the vanadium oxide containing vanadium having a valency number other than four is V₂O₃, V₃O₅, V₆O₁₃, V₃O₇ or V₂O₅.

6. The vanadium oxide-containing particles each having a core-shell structure according to claim 5, wherein the vanadium oxide containing vanadium having a valency number other than four is V₂O₃ or V₂O₅.

7. A film comprising the vanadium oxide-containing particles each having a core-shell structure according to claim 1.

8. The vanadium oxide-containing particles each having a core-shell structure according to claim 2, wherein the shell layer has a layer thickness that is within a range of 2.5 to 25% of an average particle size of the vanadium oxide-containing particles each having a core-shell structure.

9. The vanadium oxide-containing particles each having a core-shell structure according to claim 2, wherein the vanadium oxide containing vanadium having a valency number other than four is V₂O₃, V₃O₅, V₆O₁₃, V₃O₇ or V₂O₅.

10. A film comprising the vanadium oxide-containing particles each having a core-shell structure according to claim 2.

11. The vanadium oxide-containing particles each having a core-shell structure according to claim 3, wherein the shell layer has a layer thickness that is within a range of 2.5 to 25% of an average particle size of the vanadium oxide-containing particles each having a core-shell structure.

12. The vanadium oxide-containing particles each having a core-shell structure according to claim 3, wherein the vanadium oxide containing vanadium having a valency number other than four is V₂O₃, V₃O₅, V₆O₁₃, V₃O₇ or V₂O₅.

13. A film comprising the vanadium oxide-containing particles each having a core-shell structure according to claim 3.

14. The vanadium oxide-containing particles each having a core-shell structure according to claim 4, wherein the vanadium oxide containing vanadium having a valency number other than four is V₂O₃, V₃O₅, V₆O₁₃, V₃O₇ or V₂O₅.

15. A film comprising the vanadium oxide-containing particles each having a core-shell structure according to claim 4.

16. A film comprising the vanadium oxide-containing particles each having a core-shell structure according to claim 5.

17. A film comprising the vanadium oxide-containing particles each having a core-shell structure according to claim 6.
